(19) United States
(12) Patent Application Publication
(10) Pub. No.: US 2012/0088203 A1
(43) Pub. Date: Apr. 12, 2012

(54) Heat Treatment Apparatus and Heat Treatment Method

(76) Inventors: Kouichi Mizunaga, Koshi-City (JP); Kazuhiko Ooshima, Koshi-City (JP); Yasuhiro Takaki, Koshi-City (JP)

(21) Appl. No.: 13/241,848

(22) Filed: Sep. 23, 2011

(30) Foreign Application Priority Data
Oct. 7, 2010 (JP) 2010-227159
Jun. 2, 2011 (JP) 2011-123952

(51) Int. Cl. F27D 5/00

(52) U.S. Cl. 432/253

(57) ABSTRACT

Disclosed is a heat treatment apparatus which includes a plurality of first disposing support members having an extendable elastic member to provide a first gap distance between a substrate disposing surface of a heat treatment plate and the rear surface of the substrate; a plurality of second disposing support members providing a second gap distance, which is smaller than the first gap distance, between the substrate disposing surface and the rear surface of the substrate; and a plurality of suction holes disposed at the substrate disposing surface of the heat treatment plate and sucking a space of the gap between the substrate disposing surface and the rear surface of the substrate, in which the substrate supported on the first disposing support member is sucked by the suction holes, such that the first disposing support member is contracted and the substrate is supported on the second disposing support member.

### CROSS-REFERENCE TO RELATED APPLICATIONS

This application is based on and claims priority from Japanese Patent Application Nos. 2010-227159 and 2011-123952, filed on Oct. 7, 2010 and Jun. 2, 2011, respectively, with the Japanese Patent Office, the disclosures of which are incorporated herein in their entireties by reference.

### TECHNICAL FIELD

The present disclosure relates to a heat treatment apparatus and a heat treatment method used for the heat treatment performed on a substrate before or after performing a liquid processing such as a resist coating processing, a developing processing, or the like on the substrate for manufacturing a semiconductor device, a flat panel display (FPD), and the like.

### BACKGROUND

For example, in a photoresist processing in manufacturing a semiconductor device, a resist solution is coated on the surface of a substrate such as a semiconductor wafer (hereinafter, referred to as a “wafer”) to form a resist film, and then, a developing processing is performed by coating a developer on the corresponding substrate after exposing a predetermined pattern on the resist film. In performing a series of processing, a resist coating and developing apparatus and an exposing apparatus have been used conventionally.

The resist coating and developing apparatus includes a plurality of processing units individually performing a series of processings required to the coating and developing processing. The coating processing unit performs the coating of the resist solution and the developing processing unit performs the developing processing that develops the substrate after exposing. The resist coating and developing apparatus includes a heat treatment unit performing curing of the resist film by heating the substrate after coating the resist solution and includes a heat treatment unit used before and after the developing processing in order to heat the substrate at a predetermined temperature after exposing. In carrying into and out of the wafer between the processing units and for each processing unit, a substrate carrying apparatus is provided configured so as to transfer the wafer held therein to each processing unit.

A heat treatment plate and a cooling plate are provided in the heat treatment unit. When the substrate is transferred from the substrate carrying apparatus to the heat treatment unit, the substrate is transferred to the cooling plate. The cooling plate moves with the substrate held therein to transfer the substrate to the heat treatment plate, thereby performing the heat treatment. That is, a configuration in which the cooling plate can retreatably move between the cooling plate and the heat treatment plate was known (see, for example, FIGS. 4, 5 and 7 of Japanese Patent Application Laid-Open No. 2006-303104). A heat treatment plate including suction holes for adsorbing the substrate disposed at the heat treatment plate was known (see, for example, FIGS. 5 and 6 of Japanese Patent Application Laid-Open No. 2008-177303).

According to a type of the coating and developing apparatus disclosed in, for example, FIGS. 3, 6 and 12 of Japanese Patent Application Laid-Open No. 2010-118446, the coating and developing apparatus is disposed between a process processing block and a carrier station block to have a transfer function of the substrate, and is used for cooling the substrate as the heat treatment at a predetermined temperature before a coating processing or before or after the developing processing. The suction holes for adsorbing the substrate on the cooling plate surface are included in the cooling plate in order to increase cooling efficiency.

### SUMMARY

An exemplary embodiment of the present disclosure provides a heat treatment apparatus including: a heat treatment plate configured to perform a heating processing or a cooling processing for a substrate disposed thereon; a plurality of first disposing support members including an elastic member which is entirely and partially extendable and configured to provide a first gap distance between a substrate disposing surface of the heat treatment plate and the rear surface of the substrate; a plurality of second disposing support members configured to provide a second gap distance, which is smaller than the first gap distance, between the substrate disposing surface and the rear surface of the substrate; and a plurality of suction holes disposed at the substrate disposing surface of the heat treatment plate and configured to suck a space of the gap between the substrate disposing surface and the rear surface of the substrate. In particular, one or more suction holes and the second disposing support member are disposed near the center of one first disposing support member and the substrate supported on the first disposing support member is sucked by the suction holes, such that the first disposing support member is contracted and the substrate is supported on the second disposing support member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of a resist processing apparatus applying a heat treatment apparatus according to an exemplary embodiment of the present disclosure.

FIG. 2 is a perspective view of the resist processing apparatus.

FIG. 3 is a perspective view illustrating the configuration of a cooling plate group which is provided at a carrier block side having a function of transferring a substrate.

FIG. 4 is a perspective view illustrating the configuration of a cooling plate group which is provided at an interface side having a function of transferring a substrate.

FIG. 5 is a cross-sectional view illustrating an overall heat treatment apparatus according to an exemplary embodiment of the present disclosure.

FIG. 6 is a plan view illustrating an overall cooling plate according to an exemplary embodiment of the present disclosure.

FIG. 7 is a plan view illustrating a relationship between a transfer arm and a carrying arm according to an exemplary embodiment of the present disclosure.

FIG. 8 is a plan view illustrating an overall cooling plate according to an exemplary embodiment of the present disclosure.

FIG. 9 is a cross-sectional view illustrating states before or when receiving a wafer on a first disposing support member, a second disposing support member, and suction holes according to an exemplary embodiment of the present disclosure.

FIGS. 10A and 10B are cross-sectional views illustrating operational states of the first disposing support member, the second disposing support member, and the suction holes according to the exemplary embodiment of the present disclosure.

FIGS. 10C and 10D are cross-sectional views illustrating an operational state of the case where a coil spring setting a spring constant is used in the first disposing support member according to the exemplary embodiment of the present disclosure.

FIG. 11 is a cross-sectional view illustrating a modified example of the case where a spring is used in the first disposing support member according to the exemplary embodiment of the present disclosure.

FIG. 12 is a cross-sectional view illustrating a modified example of the case where a rubber is used in the first disposing support member according to the exemplary embodiment of the present disclosure.

FIG. 13 is a cross-sectional view illustrating a modified example of the case where a sponge is used in the first disposing support member according to the exemplary embodiment of the present disclosure.

FIG. 14 is a schematic cross-sectional view illustrating a state where a first disposing support member corresponds to a substrate having a convex and concave curve according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Recently, the productivity of manufacturing semiconductor devices has been improved and the throughput of an exposing apparatus in a lithography process becomes 300 sheets every hour and a resist coating and developing apparatus is also required to correspond to the throughput. Among this, according to the demand, the resist coating and developing apparatus is required to consider shortening of the operation time except for the process time in various processing units.

A heat treatment apparatus is one of the targets to be improved. Japanese Patent Application Laid-Open No. 2006-303104 discloses that carrying in/out time of the heating processing unit performing carrying in/out of the substrate from the cooling plate to the heating unit was shortened without sacrificing process performance. Further, Japanese Patent Application Laid-Open Nos. 2008-177303 and 2010-118446 disclose that, in order to shorten the process time, the heat treatment is efficiently performed by adsorbing the substrate to pull the substrate. However, if the substrate is rapidly transferred to the heat treatment plate and rapidly descended in order to shorten the time for completing the transfer, air compression occurs during the descending of the upper surface of the heat treatment plate and the substrate, such that the substrate is side-slipped due to an air bearing phenomenon before the substrate is contacted to the heat treatment plate.

In Japanese Patent Application Laid-Open Nos. 2008-177303 and 2010-118446, the case where the substrate is adsorbed is disclosed, but the substrate is side-slipped before the adsorption effect is generated, such that the substrate is not adsorbed at a proper position. If the air bearing phenomenon occurs, the edge of the substrate may be seated on or collide with a protruding prevention guide provided at the heat treatment plate. When the substrate is transferred to the carrying apparatus after processing, a receiving error may be generated.

The present disclosure has been made in an effort to provide a heat treatment apparatus and a heat treatment method performing a proper heat treatment so that misalignment of a substrate does not occur by the sideslip of the substrate due to the air bearing phenomenon when the substrate is transferred to a heat treatment plate.

An exemplary embodiment of the present disclosure provides a heat treatment apparatus including: a heat treatment plate configured to perform a heating processing or a cooling processing for a substrate disposed thereon; a plurality of first disposing support members including an elastic member which is entirely and partially extendable and configured to provide a first gap distance between a substrate disposing surface of the heat treatment plate and the rear surface of the substrate; a plurality of second disposing support members configured to provide a second gap distance, which is smaller than the first gap distance, between the substrate disposing surface and the rear surface of the substrate; and a plurality of suction holes disposed at the substrate disposing surface of the heat treatment plate and configured to suck a space of the gap between the substrate disposing surface and the rear surface of the substrate. In particular, one or more suction holes and the second disposing support member are disposed near the center of one first disposing support member and the substrate seated on the second disposing support member is sucked by the suction holes, such that the first disposing support member is contracted to support the substrate on the second disposing support member.

According to the above configuration, before the substrate is disposed at the second disposing support member (hereinafter, referred to as a proximity spacer) which is the proximity spacer disposed at the heat treatment plate, the substrate is supported by providing the first disposing support member which can support the substrate at a further higher position than the proximity spacer. As a result, it is possible to remove the sideslip generated by an air compression effect of the substrate. A gap having substantially the same height is formed between the rear surface of the substrate and the heat treatment plate, and the gap is not side-slipped, such that a suction effect is more uniformly provided. The first disposing support member is entirely or partially configured by the extendable elastic member and the substrate is sucked and pulled on the heat treatment plate, such that the first disposing support member is contracted and the substrate is pressed at the proximity spacer for having an actual heat treatment height, thereby providing the second gap distance. Since a suction force is used, an elevating mechanism using an actuator does not need to be provided at the first disposing support member. The suction holes are provided around the first disposing support member and the proximity spacer, such that the elastic member can be certainly contracted.

Another exemplary embodiment of the present disclosure provides a heat treatment apparatus including: a heat treatment plate configured to perform a heat processing or a cooling processing for a substrate disposed thereon; a plurality of first disposing support members including an elastic member which is entirely and partially extendable in order to provide a first gap distance between a substrate disposing surface of the heat treatment plate and the rear surface of the substrate; a plurality of second disposing support members configured to provide a second gap distance, which is smaller than the first gap distance, between the substrate disposing surface and the rear surface of the substrate; and a plurality of suction holes disposed at the substrate disposing surface of the heat treatment plate and configured to suck a space of the gap between the substrate disposing surface and the rear surface of the substrate. In particular, the elastic member of the first disposing support member is formed of a coil spring, a spring constant in which the coil spring is repulsive with respect to a self-weight of the substrate is set to be small, and the substrate is supported on the first disposing support member, such that the substrate is slowly sunken while including a repulsive effect to be seated on the second disposing support member, and one or more suction holes and the second disposing support member are disposed near the center of one first disposing support member and the substrate that is supported on the first disposing support member is sucked by the suction holes, such that the first disposing support member is contracted and the substrate is supported on the second disposing support member.

According to the above configuration, before the substrate is disposed at a proximity spacer (the second disposing support member) disposed at the heat treatment plate, the substrate is supported by providing the first disposing support member which can support the substrate at a further higher position than the proximity spacer. As a result, it is possible to remove the sideslip generated by an air compression effect of the substrate. The elastic member of the first disposing support member is formed of a coil spring, a spring constant in which the coil spring is repulsive with respect to a self-weight of the substrate is set to be small, and the substrate is supported on the first disposing support member, such that the substrate is slowly sunken while including a repulsive effect to be seated on the second disposing support member, thereby providing the second gap distance. Since the elastic member of the first disposing support member is formed of the coil spring in which the spring constant that is repulsive with respect to the self-weight of the substrate is set to be small, an elevating mechanism using an actuator does not need to be provided at the first disposing support member.

The suction holes are provided around the first disposing support member and the proximity spacer, such that the elastic member can be certainly contracted.

In the heat treatment apparatus of the present disclosure, the elastic member may be formed of any one of a rubber member, a sponge member, and a spring member.

According to the above configuration, a material having an elastic force suitable for a suction force can be easily selected.

In the heat treatment apparatus, the first disposing support member may be configured by combining the elastic member with a hard member.

According to the above configuration, for example, if a contact surface to the rear surface of the substrate is made of a material such as a synthetic resin of, for example, a fluorine resin, polyetheretherketone (PEEK), polytetrafluoroethylene (PTFE), or the like or ceramics as a hard member, a material in which abrasion or resection (scratch) of the substrate contact surface due to the material can be prevented may be selected. Further, it is possible to stabilize the contact state. The hard member is provided at the bottom of the elastic member so as to be easily screw-fastened at the heat treatment plate, such that it is possible to prevent detachment of the first disposing support member.

In the heat treatment apparatus, when the first disposing support member, the second disposing support member, and the suction hole are considered as an integral combination, the heat treatment plate may be provided so that the combination is positioned at the circumferential edge of the substrate disposed at the heat treatment plate.

According to the above configuration, although a curve of the substrate is in a convex shape, since the substrate is first supported and received by the first disposing support member around a circumferential edge of the substrate, the substrate can be adsorbed without sideslip.

In the above described heat treatment apparatus, when the first disposing support member, the second disposing support member, and the suction hole are considered as an integral combination, the heat treatment plate may be provided so that the combination is positioned around the center of the substrate disposed at the heat treatment plate.

According to the above configuration, although the curve of the substrate is in a concave shape, since the substrate is first supported and received by the first disposing support member around the center of the substrate, the substrate can be adsorbed without sideslip.

Yet another exemplary embodiment of the present disclosure provides a heat treatment method of a heat treatment apparatus performing a heat processing or a cooling processing on a substrate, the method includes disposing the substrate at a heat treatment plate for the heating processing or the cooling processing; preparing a predetermined first gap distance between a substrate disposing surface of the heat treatment plate and the rear surface of the substrate during the disposing process by providing a extendable first disposing support member at the heat treatment plate; sucking a space where the first gap distance is provided by suction holes disposed at the substrate disposing surface of the heat treatment plate; contracting the first disposing support member by the pressing of the substrate pulled by the suction of the suction process; and contacting the substrate to the second disposing support member disposed at the heat treatment plate. In particular, the substrate is heat-treated with the substrate being contacted to the second disposing support member.

According to the above process, the substrate is supported at the position of the first gap distance before the substrate is disposed at the heat treatment plate, and the suction is performed after removing the sideslip generated in air compression. As a result, it is possible that the substrate may be adsorbed and heat-treated at the heat treatment plate without the misalignment of the substrate by contracting the first disposing support member. Since the misalignment due to the sideslip does not occur, the heat treatment can be properly performed and a receiving error does not occur when wafer is transferred to the carrying apparatus in the coating and developing apparatus after the heat treatment.

In the above described heat treatment method of the present disclosure, the suction process may start before the substrate is contacted to the first disposing support member.

According to the above configuration, since the substrate is suctioned toward the heat treatment plate before the air compression effect occurs, it is possible to surely prevent misalignment of the substrate.

Still another exemplary embodiment of the present disclosure provides a heat treatment method of a heat treatment apparatus performing a heating processing or a cooling processing on a substrate, the method includes disposing the substrate at a heat treatment plate for the heating processing or the cooling processing; providing extendable first disposing support member and second disposing support member in the heat treatment plate, the extendable first disposing support member is configured by a coil spring and set to have a small repulsive spring constant of the coil spring with respect to a self-weight of the substrate; seating the substrate on the second disposing support member by being slowly sunken while including a repulsive effect and by supporting the substrate on the first disposing support member during the disposing process; and suctioning a space provided between the substrate disposing surface of the heat treatment plate and the rear surface of the substrate supported on the first disposing support member by suction holes disposed at the substrate disposing surface of the heat treatment plate. In particular, the substrate is heat-treated with the substrate being contacted to the second disposing support member.

According to the above described method, the substrate is supported on the first disposing support member after removing the sideslip generated in air compression before the substrate is disposed at the heat treatment plate, by supporting the substrate at a position of the first gap distance. As a result, the substrate may be disposed and heat-treated at the heat treatment plate without misalignment of the substrate by contracting the first disposing support member by being slowly sunken while including a repulsive effect to seat the substrate on the proximity spacer (the second disposing support member). Since the misalignment due to the sideslip does not occur, the heat treatment can be properly performed and a receiving error does not occur when wafer is transferred to the carrying apparatus in the coating and developing apparatus after the heat treatment.

The substrate is sucked by the suction holes disposed at the substrate disposing surface of the heat treatment plate, such that the coil spring can be certainly contracted.

In the heat treatment method of the present disclosure, the suction process may start before the substrate is seated to the second disposing support member.

According to the above configuration, since the substrate is sucked before being seated on the proximity spacer (the second disposing support member), it is possible to surely prevent misalignment of the substrate.

As described above, according to the heat treatment apparatus (method) of the present disclosure, the following effects can be acquired by the above configurations.

It is possible to solve the problem in which the substrate is side-slipped before the substrate is disposed on the heat treatment plate, and not disposed at a predetermined position. Although a convex or concave curve is provided at a cross-section of a diameter width of the substrate, the substrate is received and sucked at the first disposing support member earlier than the second disposing support member (proximity spacer), such that the movement of the substrate can be suppressed. Accordingly, a desired heat treatment can be completed at a predetermined position. In the transfer operation of the substrate to the carrying apparatus after the heat treatment is completed and the suction is released, a transfer problem according to the misalignment is removed, such that an operation ratio for the entire apparatus can be improved.

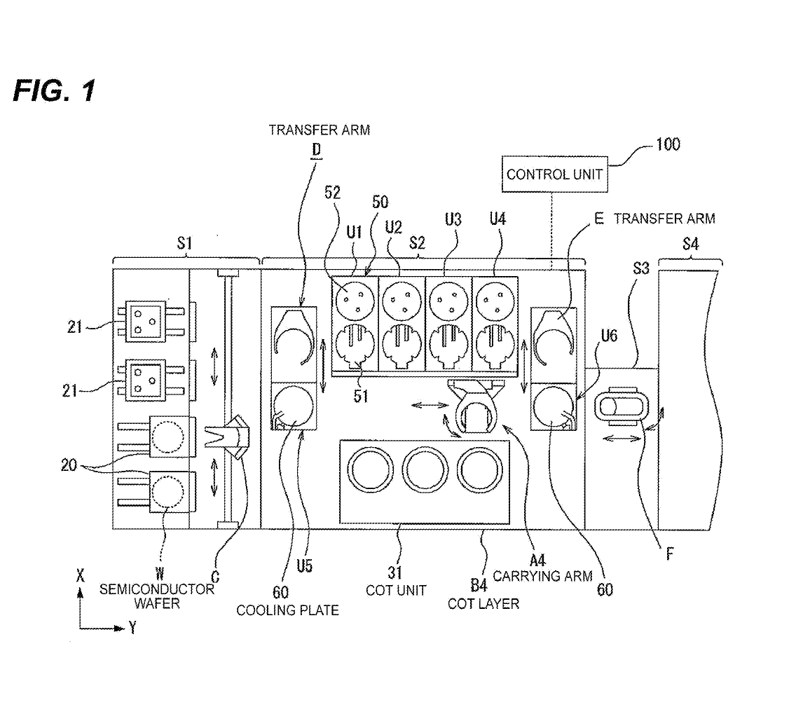

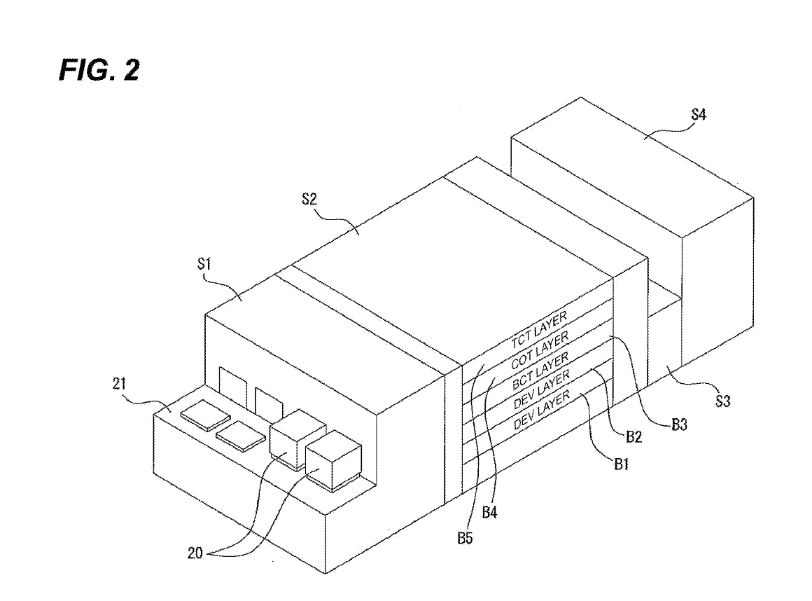

Hereinafter, a form of a coating and developing apparatus assembled with a heat treatment apparatus according to an exemplary embodiment of the present disclosure will be described. Here, the case where the heat treatment apparatus is applied to a coating and developing apparatus of a wafer W as a semiconductor substrate will be described with reference to FIGS. 1 and 2. The coating and developing apparatus has a carrier block 51 and is configured so as to extract wafer W from a carrier 20 which is a closed receiving container of wafer W disposed on a loading stand 21 by a transfer arm C to transfer the extracted wafer W to a processing block S2, and receive the processed wafer W from processing block S2 by transfer arm C to return the processed wafer W to carrier 20.

As shown in FIG. 2, processing block S2 is configured by stacking first blocks (DEV layers) B1 and B2 of a developing processing apparatus for performing a developing processing, a second block (BCT layer) B3 having a lower anti-reflective film coating apparatus for forming an anti-reflective film formed at a lower side of a resist film, a third block (COT layer) B4 having a resist coating processing apparatus for coating the resist film, and a fourth block (TCT layer) B5 of an upper anti-reflective film coating apparatus for forming an anti-reflective film formed at an upper side of the resist film in sequence from the bottom.

The resist coating and developing apparatus includes a liquid processing apparatus coating chemicals on first blocks (DEV layers) B1 and B2, second block (BCT layer) B3 for forming an anti-reflective film formed at a lower side of a resist film, third block (COT layer) B4 for coating the resist film, and fourth block (TCT layer) B5 for forming an anti-reflective film formed at an upper side of the resist film, a heat treatment apparatus which is a processing unit of a heating and cooling system according to the exemplary embodiment in order to perform pre-processing and post-processing of the processing performed by the liquid processing apparatus, and a carrying arm A4 provided between the liquid processing apparatus and the heat treatment apparatus and for example, carrying wafer W therebetween in COT layer B4, and as described above, the resist coating and developing apparatus is configured to include a carrying arm A1 (DEV layer), a carrying arm A3 (BCT layer), and a carrying arm A5 (TCT layer) (not shown).

For example, in third block (COT layer) B4, as shown in FIG. 1, three cups coating the resist are provided in a COT unit 31 with respect to each layer. Each unit of processing unit groups U1, U2, U3, and U4 of the heating and cooling system is arranged by contacting a linear carrying path in a form engaged between the linear carrying path of carrying arm A4. Each unit of processing unit groups U1, U2, U3, and U4 is configured by a double stage and total eight processing units are provided in FIG. 1.

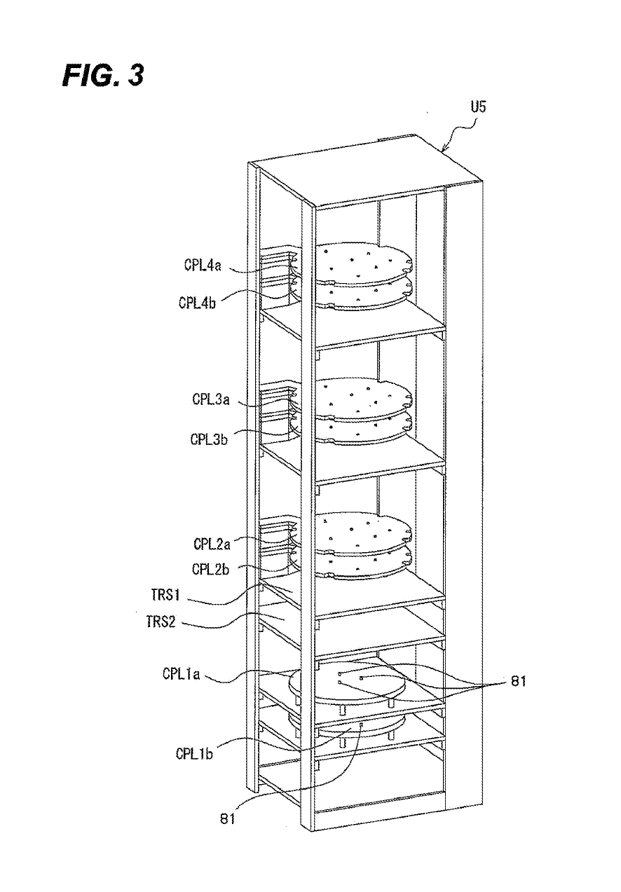

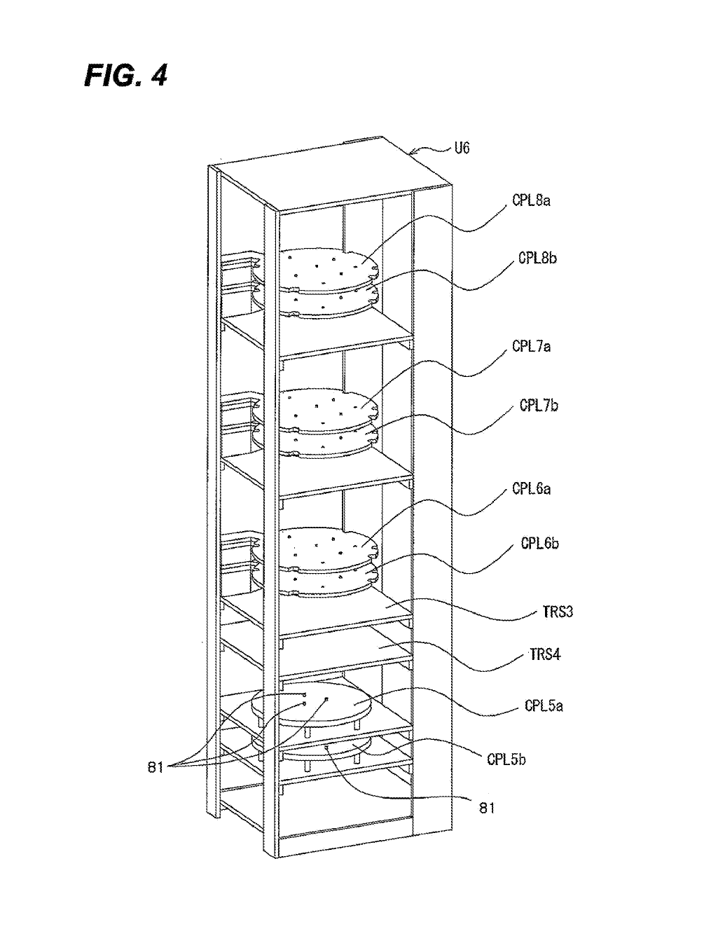

As shown in FIGS. 1 and 3, processing block S2 has a shelf unit U5 and wafer W is transferred from carrier block S1 to transition stages TRS1 and TRS2 which are configured by three pins which are the transfer unit of shelf unit U5 by transfer arm C and is sequentially carried to cooling processing units CPL2a and CPL2b (cooling plates) corresponding to second block (BCT layer) B3 by an elevatable transfer arm D provided around a lateral side of shelf unit U5. FIG. 4 of the same configuration is a diagram illustrating a shelf unit U6 adjacent to an interface block S3 opposite to carrier block S1 with processing block S2 disposed therebetween and is the same configuration as FIG. 3, and a transfer arm E that is elevatable can transfer wafer W to each layer of shelf unit U6.

The carrying arm (not shown) in second block (BCT layer) B3 receives wafer W from cooling processing units CPL2a and CPL2b, and carries received wafer W to each unit (the anti-reflective film coating unit and the processing unit group of the heating and cooling system). The anti-reflective film is formed on wafer W by the units, and wafer W processed in the BCT layer is carried to cooling processing units CPL6a and CPL6b of shelf unit U6, carried to cooling processing units CPL7a and CPL7b corresponding to the COT layer by transfer arm E, and transferred to each processing unit by carrying arm A4 of the COT layer to perform the resist coating processing.

Thereafter, as described above, wafer W is carried to cooling processing units CPL3a and CPL3b, received by transfer arm D, and transferred to cooling processing units CPL4a and CPL4b to perform a desired anti-reflective film coating processing by carrying arm A4 of the TCT layer. Thereafter, wafer W is transferred to cooling units CPL8a and CPL8b of shelf unit U6 and transferred to TRS3 and TRS4 by transfer arm E. Wafer W is transferred to an exposing device S4 by a transfer arm F disposed in interface block S3. Wafer W carried out from exposing device S4 is received by transfer arm F and transferred to CPL5a and CPL5b where substrate support pins 81 for supporting wafer W are drawably configured and then, the developing processing is performed on wafer W in DEV layers B1 and B2 and wafer W is transferred to cooling units CPL1a and CPL1b, received in transfer arm C of carrier block S1, and stored in carrier 20.

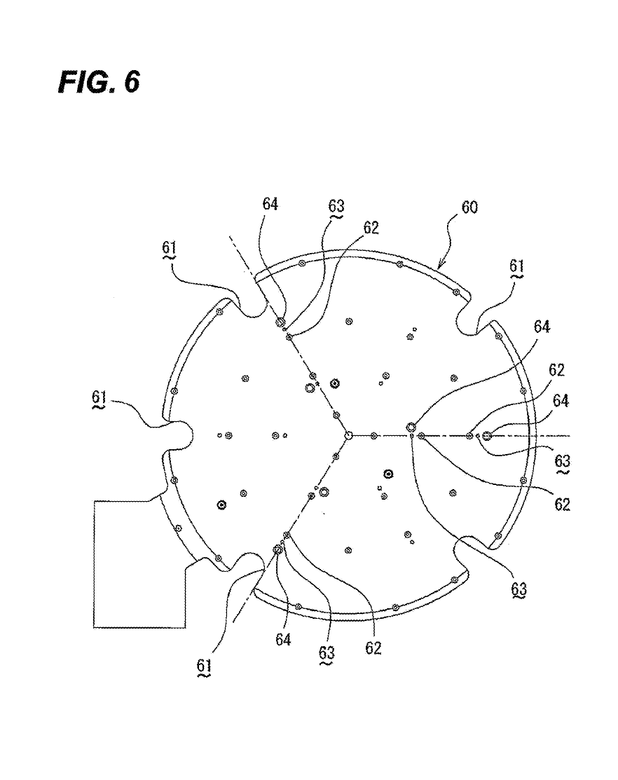

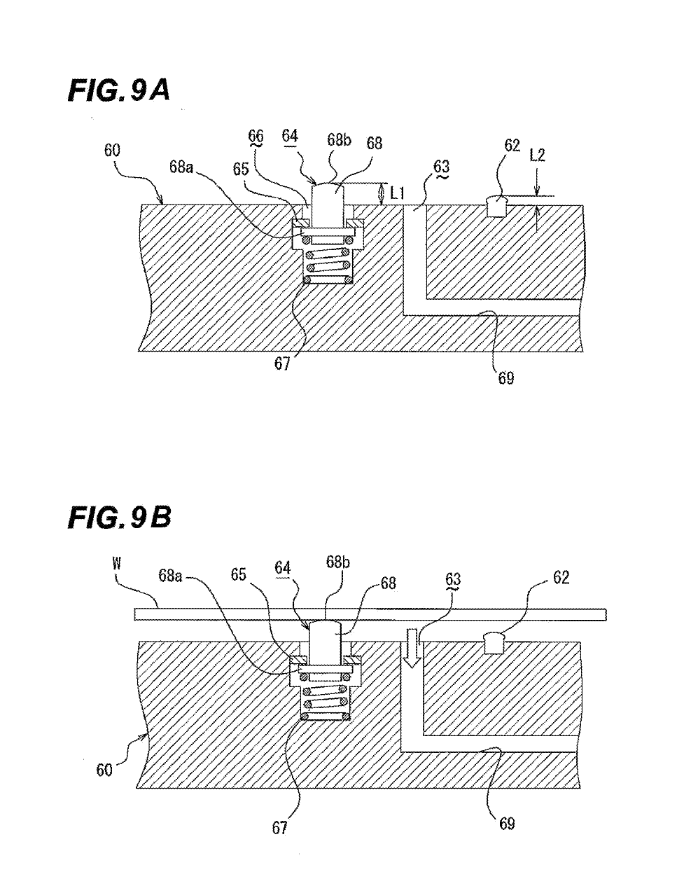

Hereinafter, a heat treatment apparatus according to an exemplary embodiment of the present disclosure will be described with reference to FIGS. 1 and 5 to 9. For example, cooling processing units (CPL2a, CPL2b) to (CPL4a, CPL4b), (CPL6a, CPL6b) to (CPL8a, and CPL8b) having a cooling plate 60, which are provided at shelf units U5 and U6 shown in FIG. 1, will be described as an example to which the present disclosure is applied. FIG. 9 shows a cross-sectional view of cooling plate 60 showing a main structure configuring the present disclosure. FIG. 6 is a plan view of cooling processing unit CPL3a. Cooling processing unit CPL3a is a disk plate having a thickness of, for example, about 20 mm, and a flow channel of temperature controlling water (not shown) for cooling the plate is provided therein to be capable of cooling wafer W. A suction channel 69 is provided in the plate shown in FIG. 9 other than the flow channel of temperature controlling water.

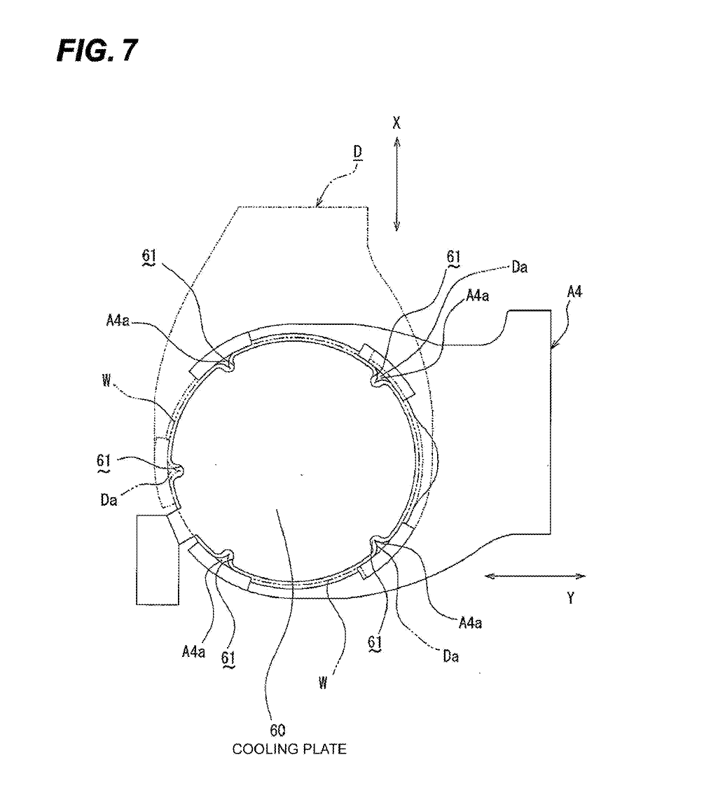

Next, referring back to FIG. 6, constituent elements disposed on cooling plate 60 when viewed from above will be described. Cooling plate 60 of CPL3a provided on shelf unit U5 is provided with, for example, five notches 61 disposed around an edge so as to dispose or receive wafer W from both directions of transfer arm D and carrying arm A4. Substrate support parts Da and A4a supporting wafer W are provided on both arms, respectively. Wafer W can be transferred between carrying arm A4 and cooling plate 60 by passing notches 61, for example, carrying arm A4 with wafer W held so as to be transferred to cooling plate 60 without interference. The relationship diagram was shown in FIG. 7. Three substrate support parts Da of transfer arm D and for example, four substrate support parts A4a of carrying arm A4 of COT layer correspond to notches 61 of cooling plate 60.

On cooling plate 60, a plurality of first disposing support members 64, a plurality of proximity spacers 62 which are second disposing support members, and a plurality of suction holes 63 performing suction in order to closely contact wafer W to cooling plate 60 are provided. First disposing support member 64, proximity spacer 62 and suction hole 63 are configured as one combination and disposed around each other and for example, the combination is disposed on lines dividing wafer W into an angle of 120 degrees based on the center of wafer W. In FIG. 6, two combinations are shown as an example. One of two combinations is arranged by disposing proximity spacer 62 at the center side of cooling plate 60, first disposing support member 64 around the edge, and suction hole 63 therebetween in a region disposed around the edge of wafer W disposed at cooling plate 60. The other of two combinations is disposed so that a line connecting first disposing support member 64, suction hole 63, and proximity spacer 62 becomes a triangle in a region disposed around the center of wafer W disposed at cooling plate 60. Proximity spacer 62 is made of a resin or ceramics.

The layout of three elements (i.e., first disposing support member 64, proximity spacer 62 and suction hole 63) is free, but the three elements need to be disposed around each other. A distance therebetween in which three elements are disposed may be within 20 mm FIG. 9 shows a cross-sectional view of a state where first disposing support member 64, suction hole 63, and proximity spacer 62 are arranged. First disposing support member 64 has a gap height of L1 from the surface of cooling plate 60 (a first gap distance) and gap height L1 is, for example, 1.0 mm, and proximity spacer 62 has a gap height (a second gap distance) L2 of, for example, 0.1 mm Gap heights L1 and L2 are set according to a kind or state of processed substrate, but if L1 is too higher than 1.0 mm, a lot of energy for increasing suction force is required, such that it takes time to suction wafer W. If a difference between L1 and L2 is small, the suction force deteriorates, such that an air bearing phenomenon may be caused. Suction hole 63 disposed between first disposing support member 64 and proximity spacer 62 is connected to a suction unit (not shown) through suction channel 69.

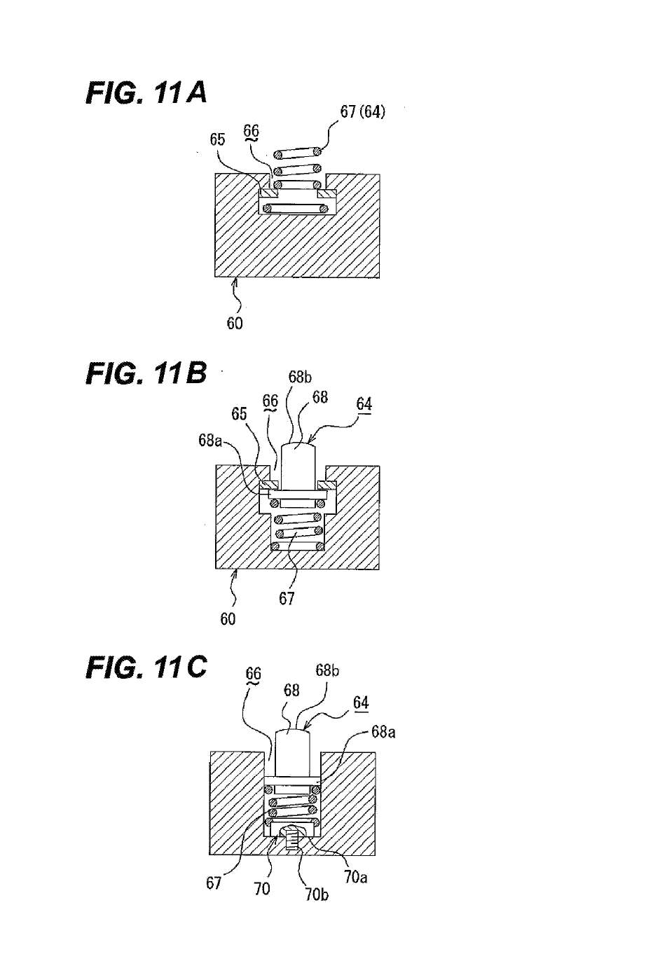

Hereinafter, first disposing support member 64 will be described in detail with reference to FIGS. 9 to 14. First, first disposing support member 64 shown in FIG. 9A is entirely configured by an elastic member such as a coil spring, a sponge, and a rubber, or may be partially configured by the elastic member and partially configured by a hard member such as a resin or ceramics. First disposing support member 64 may be configured by a combination of the elastic member and the hard member or a combination of the elastic members. An example of a configuration of first disposing support member 64 is shown in FIGS. 11 to 13 and will be described below. First disposing support member 64 is installed in a support member inserting hole 66 disposed at cooling plate 60. In this case, so that first disposing support member 64 does not protrude or is not detached from support member inserting hole 66, first disposing support member 64 has a flange part 68a disposed at a lower side of first disposing support member 64, which is engaged to, for example, a ring-shaped detachment preventing member 65 such that a movement thereof is limited.

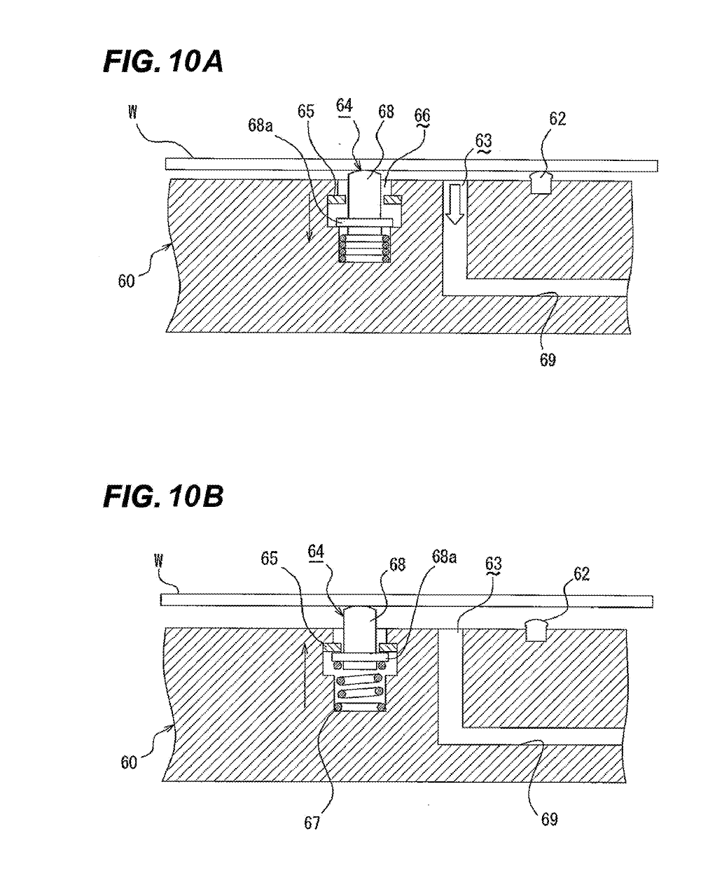

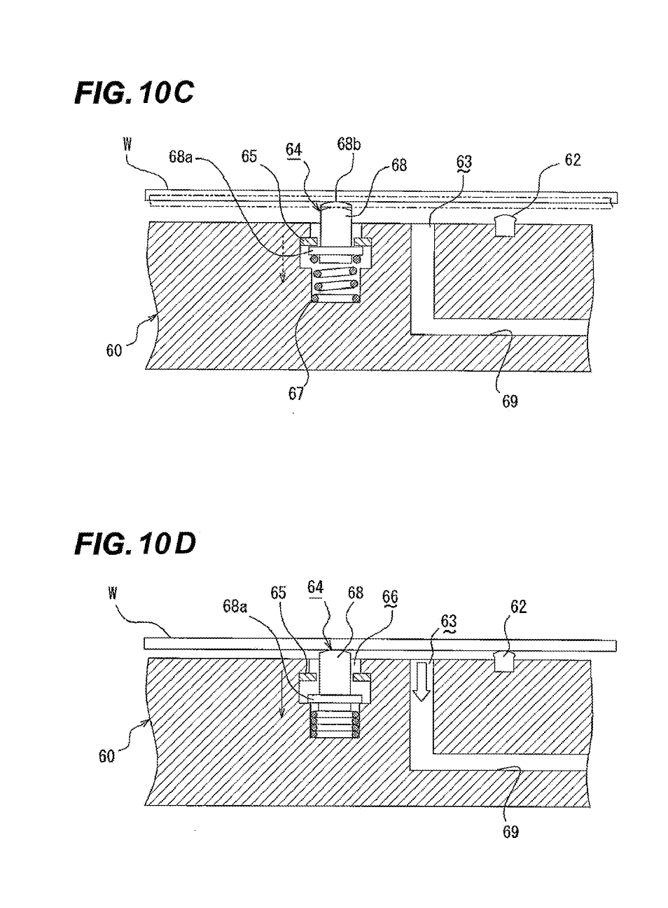

Next, FIG. 9 and FIGS. 10A and 10B are diagrams illustrating a movement of the first disposing support member. First disposing support member 64 shown in FIG. 9A is configured by combining a hard member 68 with a coil spring 67 as an elastic member. Hard member 68 is cylindrical shape and is formed of a ceramic member having a curve 68b dot-contacting wafer W at an end of a disposing side of wafer W and a flange part 68a forming a spring supporting part at a lower side thereof which is opposite to the disposing side. First disposing support member 64 can move in a up/down direction by the combination configured by two elements and is drawably configured with respect to cooling plate 60. FIG. 9A shows a state before wafer W is disposed. A material of hard member 68 may be made of, for example, a fluorine resin or a synthesized resin such as polyetheretherketone (PEEK) or polytetrafluoroethylene (PTFE) other than the ceramics.

Next, FIG. 9B shows a state where wafer W contacts first disposing support member 64. In this case, air compression occurs between cooling plate 60 and the rear surface of wafer W while wafer W is descending until contacting first disposing support member 64, such that wafer W is exposed as being close to cooling plate 60. However, the air compression is removed by supporting wafer W at a height in which wafer W does not side-slip, for example, 0.4 mm, to stop the descending, such that it is possible to prevent the sideslip. Wafer W starts to be sucked from suction holes 63 before or after contacting first disposing support member 64. By sucking wafer W before wafer W contacts first disposing support member 64, wafer W is sucked before air compression effect occurs as being close to cooling plate 60, such that it is possible to certainly prevent misalignment of wafer W.

Next, in FIG. 10A, wafer W is sucked by a suction operation to press first disposing support member 64, such that coil spring 67 is contracted to be descended in a direction settled to support member inserting hole 66 until wafer W is contacted to proximity spacer 62. The cooling processing is performed at a proper position contacting wafer W on proximity spacer 62 without generating the sideslip from the transfer position of wafer W. If the cooling processing is completed, the suction operation is released, such that coil spring 67 of first disposing support member 64 returns and extends to separate wafer W from proximity spacer 62. Subsequently, for example, transfer arm D receives wafer W by accessing and lifting wafer W from a lower side of cooling plate 60.

In the above description of FIG. 9 and FIGS. 10A and 10B, wafer W is supported by first disposing support member 64 to stop to be descended at a height where wafer W is not side-slipped, for example, 0.4 mm. However, as shown in FIGS. 10C and 10D, although wafer W is supported and does not stop to be descend at the height of 0.4 mm, and a self-weight of wafer W is applied to a plurality of first disposing support members 64, a repulsive spring constant of coli spring 67 has a small repulsive force. As a result, when wafer W is sunken by the weight itself, while a repulsive effect of coil spring 67 is included at a speed in which the sideslip of wafer W does not occur, first disposing support member 64 is sunken, and wafer W is seated on proximity spacer 62 (see FIG. 10C). In this case, since a region where the sideslip of wafer W easily occurs is 0.3 mm or less, the gap height (the first gap distance) of L1 may be 0.3 mm or more, for example, about 0.6 mm Wafer W starts to be suctioned from suction holes 63 before or after wafer W is seated on proximity spacer 62 (see FIG. 10D). Since wafer W is suctioned before being seated on proximity spacer 62, it is possible to certainly prevent the misalignment of wafer W.

In the exemplary embodiment, in order to set a spring constant of coil spring 67, a weight applied to one coil spring 67, for example, mass of 107g of wafer W and self-weight of about 0.05 g of hard member 68, the number of first disposing support members 64 (the number of coil springs 67) of 9, first gap distance L1 of 0.6 mm, and second gap distance L2 of 0.1 mm are considered.

Herein, if the spring constant is represented by k (mN/mm), the weight by P (mN), and a displacement by δ(mm), k=P/δ . . . (1) is defined.

Since P=107/9+0.05=11.94(g) . . . (2) and δ=L1−L2=0.6−0.1=0.5 (mm) . . . (3) are defined, from Equations (1), (2), and (3), spring constant (k) is defined as k=11.94/0.5=23.88 (gf/mm)=23.88×9.8=234.02(mN/mm).

As described above, although the self-weight of wafer W is applied to the plurality of first disposing support member 64, the set spring constant has a small repulsive force. As a result, when wafer W is sunken by the self-weight, while a repulsive effect is included at a speed in which the sideslip of wafer W does not occur, first disposing support member 64 is slowly sunken, and wafer W may be seated on proximity spacer 62.

Wafer W is supported at a position of first gap distance L1 before wafer W is disposed on a heat treatment plate 51. Accordingly, wafer W may be supported by first disposing support member 64 after removing the sideslip generated in the air compression. First disposing support member 64 includes the repulsive effect and is slowly sunken, such that wafer W is seated on proximity spacer 62. Wafer W is disposed at the heat treatment plate side to be heated while first disposing support member 64 is contracted and wafer W is not misaligned. Since the misalignment due to the sideslip does not occur, the heat treatment can be properly performed and when wafer W is transferred to the carrying apparatus in the coating and developing apparatus after the heat treatment, a receiving error does not occur. A space provided between the substrate disposed surface of heat treatment plate 51 and the rear surface of wafer W contacted to proximity spacer 62 is suctioned by suction holes 63 disposed at the substrate disposed surface of heat treatment plate 51, such that coil spring 67 may be certainly contracted.

According to the above configuration, since the suction force (adsorptive force) due to suction holes 63 may be reduced, the labor may be reduced and influence due to damage of the rear surface of wafer W may be reduced. Since a suction time (adsorption time) is reduced, the cooling may early start up. Even in the state of suction stop, since wafer W is seated on proximity spacer 62, the cooling can be performed.

An example of another configuration of first disposing support member 64 is shown in FIGS. 11 to 13 and will be described below. FIG. 11A shows an example of using coil spring 67 as an elastic member, in which the entire first disposing support member 64 is configured of coil spring 67. FIG. 11B is the same configuration as FIG. 9A described above and shows a combination of hard member 68 at a side contacting wafer W and coil spring 67. In FIG. 11C, a combination by connecting a screw-fastened locking part 70 capable of being screw-fastenedly locked to cooling plate 60 is provided in addition to the configuration of FIG. 11B. In this case, screw-fastened locking part 70 is configured by a disk-shaped base part 70a locking the lower portion of coil spring 67 and a screw part 70b protruding the lower center of disk-shaped base part 70a. As described above, it is possible to prevent first disposing support member 64 from being removed from cooling plate 60 by screw-fastened locking without detachment preventing member 65. As shown in FIG. 11A, a spring directly contacting wafer W may be made of a synthesized resin and a spring hidden in cooling plate 60 may be made of a synthesized resin and metal. An elastic constant (a spring constant) is set according to a kind of cooling plate 60 suitable for a used temperature. In the exemplary embodiment, the case where the elastic member is coil spring 67 was described, but the elastic member may be formed by a spring member other than coil spring 67.

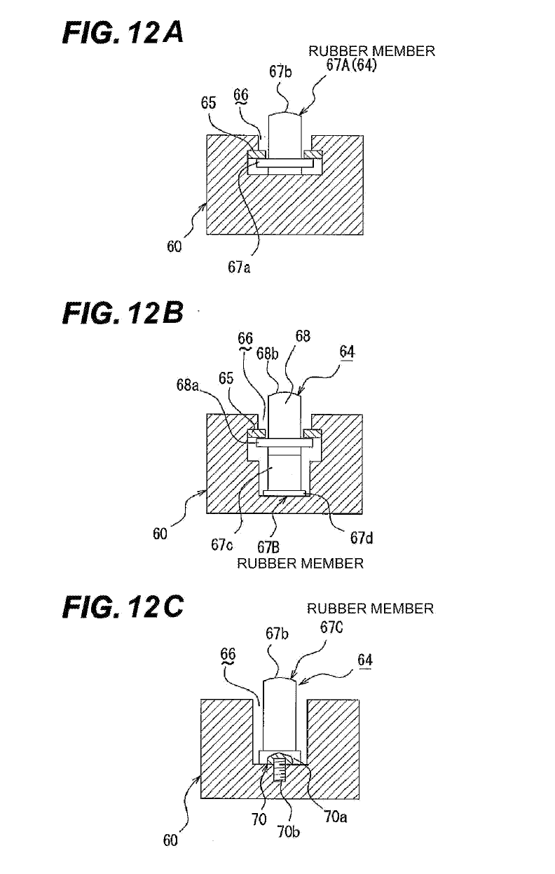

FIG. 12A shows an example of using rubber as an elastic member, in which the entire first disposing support member 64 is configured of a rubber member 67A. In this case, rubber member 67A configuring the entire first disposing support member 64 is cylindrical shape and includes a curve 67b dot-contacting wafer W at an end of a disposing side of wafer W and a flange part 67a which is engageable with detachment preventing member 65 at a lower side thereof which is opposite to the disposing side.

In FIG. 12B, a combination of hard member 68 at the contacting side with wafer W and the elastic member is used, but rubber member 67B is used as the elastic member. In this case, rubber member 67B is configured by integrally forming flange part 67d at the lower side of a cylindrical base part 67c adhered to the lower end of hard member 68.

In FIG. 12C, rubber member 67C is used at a portion contacting wafer W and extending and a screw-fastened locking part 70 capable of being screw-fastened locked to cooling plate 60 attached at the lower side thereof to be combined with each other. In this case, rubber member 67C is cylindrical shape and has curve 67b dot-contacting wafer W at the end of the disposing side of wafer W. As described above, it is possible to prevent first disposing support member 64 from being removed from cooling plate 60 by the screw-fastened locking without detachment preventing member 65.

Materials of rubber members 67A, 67B, and 67C are selected and determined in consideration of drug resistance, heat resistance, and abrasion resistance other than the elastic constant. For example, synthetic rubber of, for example, silicon rubber and the like may be used as the materials of rubber members 67A, 67B, and 67C. Although not shown, screw-fastened locking part 70 may be combined at the lower side of the elastic member as the configuration of FIG. 12B.

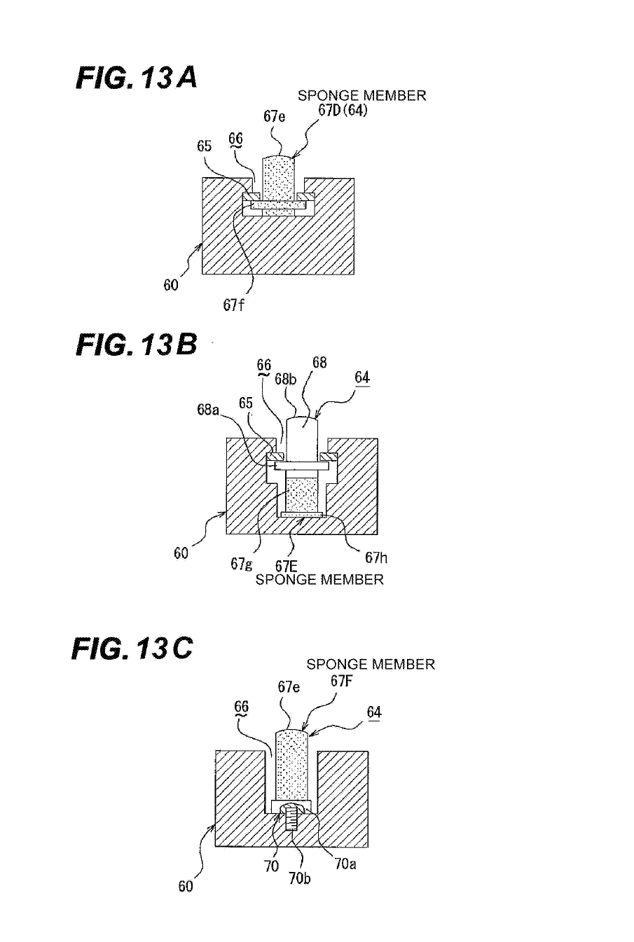

FIG. 13A shows an example of using a sponge as the elastic member 67, in which the entire first disposing support member 64 is configured by a sponge member 67D. In this case, sponge member 67D configuring the entire first disposing support member 64 is cylindrical shape and includes a curve 67e dot-contacting wafer W at an end of a disposing side of wafer W and a flange part 67f which is engageable with detachment preventing member 65 at a lower side thereof which is opposite to the disposing side.

In FIG. 13B, a combination of hard member 68 at the contacting side with wafer W and the elastic member is used, but a sponge member 67E is used as the elastic member. In this case, sponge member 67E is configured by integrally forming flange part 67h at the lower side of cylindrical base part 67g adhered to the lower end of hard member 68.

In FIG. 13C, a sponge member 67F is used at a portion contacting wafer W and extending and a screw-fastened locking part 70 capable of being screw-fastened locked to cooling plate 60 to the lower portion thereof is attached and to be combined with each other. In this case, sponge member 67F is, for example, cylindrical shape and has curve 67e dot-contacting wafer W at the end of the disposing side of wafer W, and screw-fastened locking part 70 is attached to the lower end thereof. As described above, it is possible to prevent first disposing support member 64 from being removed from cooling plate 60 by the screw-fastened locking without detachment preventing member 65.

Materials of sponge members 67D, 67E, and 67F are selected and determined in consideration of drug resistance, heat resistance, and abrasion resistance other than the elastic constant. For example, a sponge made of a silicon-based material may be used. Although not shown, screw-fastened locking part 70 may be combined at the lower side of the elastic member as the configuration of FIG. 13B.

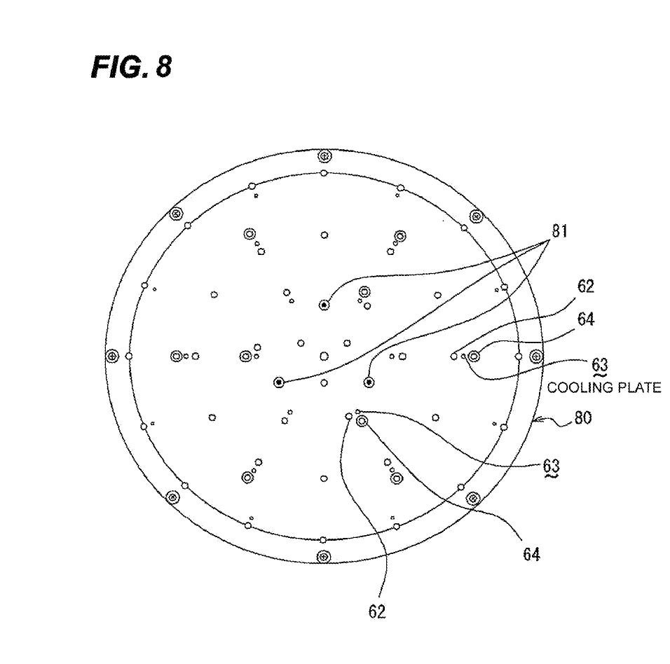

Next, a cooling plate 80 having a configuration of FIG. 8 to which the present disclosure is applied will be described as another exemplary embodiment. FIG. 8 is a plan view of CPL1a, CPL1b, CPL5a, and CPL5b provided at shelf unit U5 shown in FIG. 3 and shelf unit U6 shown in FIG. 4, respectively, in which three substrate support pins 81 (hereinafter, referred to as three pins 81) which are elevatable and drawable are included. Cooling plate 80 is different from cooling plate 60 described above in that cooling plate 80 transfers wafer W between transfer arms D and E and carrying arm A1 in cooling process through three pins 81. Even in this case, if a descending speed of three pins 81 is fast, an air bearing phenomenon occurs due to a compression effect of wafer W, such that wafer W is side-slipped and may not be disposed at a proper position. Proximity spacer 62, first disposing support member 64, and suction hole 63 described in FIG. 6 are equally configured at the disposing side of wafer W of cooling plate 80 and the same effect as those of FIG. 6 may be expected.

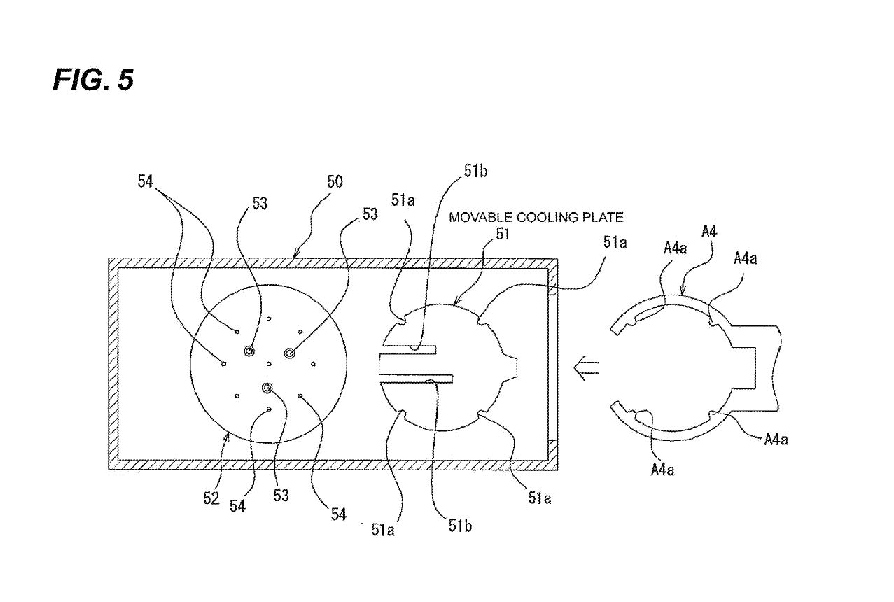

Next, a heat treatment apparatus 50 to which the present disclosure is applied will be described as another exemplary embodiment. Heat treatment apparatus 50 shown in FIG. 5 is received and installed at each unit of heating and cooling processing unit groups U1, U2, U3, and U4 shown in FIG. 1. Heat treatment apparatus 50 includes a movable cooling plate 51 for cooling a disposed wafer W, a heat treatment plate 52 for performing the heat treatment on the disposed wafer W, and three pins 53 (hereinafter, referred to as three pins 53) drawably configured on the surface of heat treatment plate 52 to support and hold wafer W. Wafer W may be transferred between movable cooling plate 51 and heat treatment plate 52 by three pins 53. Movable cooling plate 51 includes two slits 51b having an opened end corresponding to a position avoiding three pins 53 when wafer W enters into heat treatment plate 52. Heat treatment plate 52 and movable cooling plate 51 include proximity spacers 54 which are a wafer W support member for forming, for example, a gap of 100 μm between the wafer W disposing surface of the plate and the rear surface of wafer W.

Next, a transfer operation of wafer W between carrying arm A4 of the COT layer and movable cooling plate 51 will be described. First, as shown in FIG. 5, when movable cooling plate 51 is positioned at a movable end (a home position), wafer W is received by carrying arm A4. In this case, four substrate support parts A4a provided at carrying arm A4 can be vertically passed by corresponding to four side concave portions 51a of movable cooling plate 51. During the transferring, carrying arm A4 disposing wafer W is elevatably passed from top to bottom toward movable cooling plate 51 to dispose wafer W. During the receiving, the order is reversed.

Movable cooling plate 51 may retreatably move a distance to heat treatment plate 52 by a movable mechanism including a direct acting guide (not shown). Movable cooling plate 51 with wafer W enters on heat treatment plate 52 with three pins 53 sunken. Subsequently, three pins 53 protrude on the surface of heat treatment plate 52 and wafer W on movable cooling plate 51 is separated from movable cooling plate 51, and then, wafer W is supported on three pins 53. In this state, movable cooling plate 51 is retreated to the movable end. After the retreat of movable cooling plate 51, wafer W is disposed on heat treatment plate 52 with three pins 53 sunken from the surface of heat treatment plate 52. When wafer W is disposed, a cover (not shown) is descended and then, a heat treatment process starts. After a predetermined time elapses, carrying out of wafer W is performed in a reverse order.

With respect to movable cooling plate 51 to which wafer W is directly transferred from carrying arm A4 and heat treatment plate 52 to which wafer W is transferred through three pins 53, in the exemplary embodiment of the present disclosure, proximity spacer 62, first disposing support member 64, and suction hole 63 are equally configured like the description of FIGS. 6 and 8, such that the same effect as described above may be expected.

Accordingly, wafer W is not side-slipped on movable cooling plate 51 before wafer W is transferred to heat treatment plate 52 and since wafer W is sucked, wafer W is not side-slipped in movement. Since wafer W is transferred to a proper position of heat treatment plate 52 through three pins 53, the heat treatment may be properly performed on wafer W. The descending speed of three pins 53 is set at a fast speed so as not to influence wafer W, such that productivity does not deteriorate.

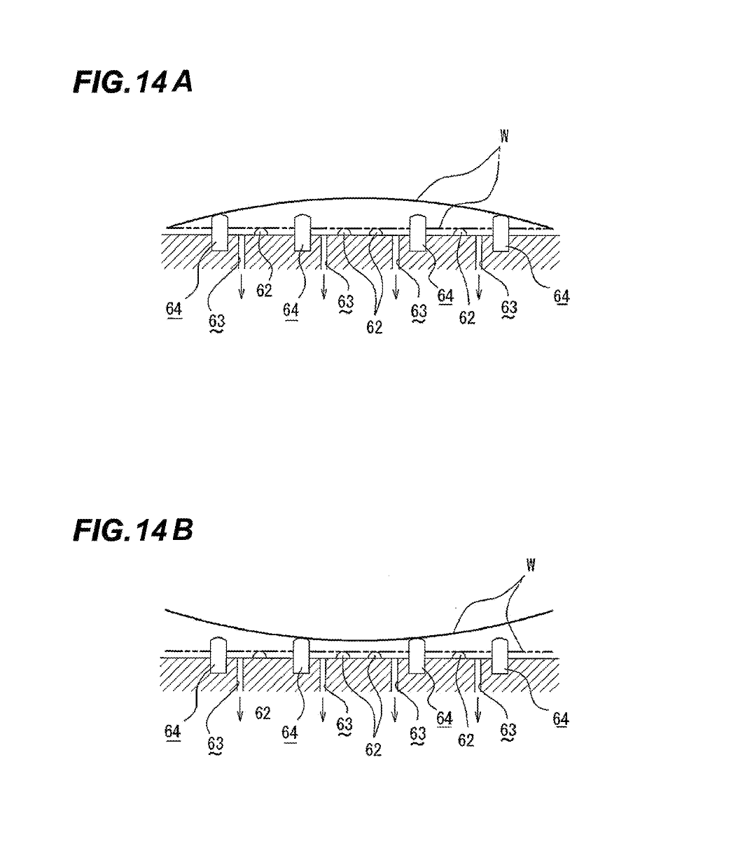

Next, FIG. 14 shows a state where wafer W is bent according to an exemplary embodiment of the present disclosure. The bending of wafer W has curved shapes of a convex shape where a circumferential edge in a plan for the processing surface is lower than the vicinity of the center (a shape turning a dish) and a concave shape opposite to the convex shape (a dish shape). FIG. 14 is extremely shown for ease of understanding. Although the convex-curved substrate is shown in FIG. 14A, since first disposing support members 64 first support the circumferential edges of wafer W, there is no problem even though first disposing support members 64 of the center cannot be contacted, and wafer W can be sucked after supporting. FIG. 14B is a diagram showing a state where first disposing support members 64 corresponds to concave-curved wafer W, but since first disposing support members 64 of the center can be first supported, even in this case, wafer W can be sucked.

In the exemplary embodiments, the case where the heat treatment apparatus according to the present disclosure is applied to the resist coating and developing apparatus system of the semiconductor wafer was described, but the heat treatment apparatus according to the present disclosure may be applied to any apparatus as long as the heat treatment apparatus is an apparatus for heat treating uniformly a flat substrate other than a processing system of a FPD substrate or a cleaning apparatus.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A heat treatment apparatus, comprising:
a heat treatment plate configured to perform a heating processing or a cooling processing for a substrate disposed thereon;
a plurality of first disposing support members including an elastic member which is entirely and partially extendable and configured to provide a first gap distance between a substrate disposing surface of the heat treatment plate and the rear surface of the substrate;
a plurality of second disposing support members configured to provide a second gap distance, which is smaller than the first gap distance, between the substrate disposing surface and the rear surface of the substrate; and
a plurality of suction holes disposed at the substrate disposing surface of the heat treatment plate and configured to suck a space of the gap between the substrate disposing surface and the rear surface of the substrate,
wherein one or more suction holes and the second disposing support member are disposed near the center of one first disposing support member and the substrate that is supported on the first disposing support member is sucked by the suction holes, such that the first disposing support member is contracted and the substrate is supported on the second disposing support member.

2. The heat treatment apparatus of claim 1, wherein the suction hole is provided between the first disposing support member and the second disposing support member.

3. The heat treatment apparatus of claim 1, wherein the first disposing support member is provided between the second disposing support member and the suction hole.

4. The heat treatment apparatus of claim 1, wherein the elastic member is any one of a rubber member, a sponge member, and a spring member.

5. The heat treatment apparatus of claim 1, wherein the first disposing support member is configured by combining the elastic member with a hard member.

6. The heat treatment apparatus of claim 5, wherein the hard member is a synthetic resin or ceramics.

7. The heat treatment apparatus of claim 1, wherein the first disposing support member is locked by being screw-fastened with the heat treatment plate by combining a screw-fastening locking part with the bottom thereof.

8. The heat treatment apparatus of claim 1, wherein when the first disposing support member, the second disposing support member, and the suction hole are considered as an integral combination, the heat treatment plate is provided so that the combination is positioned at the circumferential edge of the substrate disposed at the heat treatment plate.

9. The heat treatment apparatus of claim 1, wherein when the first disposing support member, the second disposing support member, and the suction hole are considered as an integral combination, the heat treatment plate is provided so that the combination is positioned around the center of the substrate disposed at the heat treatment plate.

10. A heat treatment apparatus, comprising:
a heat treatment plate configured to perform a heating processing or a cooling processing for a substrate disposed thereon;
a plurality of first disposing support members including an elastic member which is entirely and partially extendable and configured to provide a first gap distance between a substrate disposing surface of the heat treatment plate and the rear surface of the substrate;
a plurality of second disposing support members configured to provide a second gap distance, which is smaller than the first gap distance, between the substrate disposing surface and the rear surface of the substrate; and
a plurality of suction holes disposed at the substrate disposing surface of the heat treatment plate and configured to suck a space of the gap between the substrate disposing surface and the rear surface of the substrate,
wherein the elastic member of the first disposing support member is formed of a coil spring, a spring constant in which the coil spring is repulsive with respect to a self-weight of the substrate is set to be small, and the substrate is supported on the first disposing support member, such that the substrate is slowly sunken while including a repulsive effect to be seated on the second disposing support member, and
one or more suction holes and the second disposing support member are disposed near the center of one first disposing support member and the substrate that is supported on the first disposing support member is sucked by the suction holes, such that the first disposing support member is contracted and the substrate is supported on the second disposing support member.

11. The heat treatment apparatus of claim 10, wherein the suction hole is provided between the first disposing support member and the second disposing support member.

12. The heat treatment apparatus of claim 10, wherein the first disposing support member is provided between the second disposing support member and the suction hole.

13. The heat treatment apparatus of claim 10, wherein the first disposing support member is configured by combining the elastic member with a hard member.

14. The heat treatment apparatus of claim 13, wherein the hard member is a synthetic resin or ceramics.

15. The heat treatment apparatus of claim 10, wherein the first disposing support member is locked by being screw-fastened with the heat treatment plate by combining a screw-fastening locking part with the bottom thereof.

16. The heat treatment apparatus of claim 10, wherein when the first disposing support member, the second disposing support member, and the suction hole are considered as an integral combination, the heat treatment plate is provided so that the combination is positioned at the circumferential edge of the substrate disposed at the heat treatment plate.

17. The heat treatment apparatus of claim 10, wherein when the first disposing support member, the second disposing support member, and the suction hole are considered as an integral combination, the heat treatment plate is provided so that the combination is positioned around the center of the substrate disposed at the heat treatment plate.

18. A heat treatment method for a heat treatment apparatus performing a heating processing or a cooling processing on a substrate, the method comprising:
disposing the substrate at a heat treatment plate for the heating processing or the cooling processing;
preparing a predetermined first gap distance between a substrate disposing surface of the heat treatment plate and the rear surface of the substrate during the disposing process by providing a extendable first disposing support member at the heat treatment plate;
sucking a space where the first gap distance is provided by suction holes disposed at the substrate disposing surface of the heat treatment plate;
contracting the first disposing support member by the pressing of the substrate pulled by the suction of the suction process; and
contacting the substrate to the second disposing support member disposed at the heat treatment plate,
wherein the substrate is heat-treated with the substrate being contacted to the second disposing support member.

19. The heat treatment method of claim 18, wherein the suction process starts before the substrate contacts the first disposing support member.

20. A heat treatment method for a heat treatment apparatus performing a heating processing or a cooling processing on a substrate, the method comprising:
disposing the substrate at a heat treatment plate for the heating processing or the cooling processing;
providing extendable first disposing support member and second disposing support member in the heat treatment plate, the extendable first disposing support member is configured by a coil spring and set to have a small repulsive spring constant of the coil spring with respect to a self-weight of the substrate;
seating the substrate on the second disposing support member by being slowly sunken while including a repulsive effect, and by supporting the substrate on the first disposing support member during the disposing process; and
suctioning a space provided between the substrate disposing surface of the heat treatment plate and the rear surface of the substrate supported on the first disposing support member by suction holes disposed at the substrate disposing surface of the heat treatment plate,
wherein the substrate is heat-treated with the substrate being contacted to the second disposing support member.

21. The heat treatment method of claim 20, wherein the suction process starts before the substrate is seated to the second disposing support member.
